(19) United States
(12) Patent Application Publication
(10) Pub. No.: US 2015/0131868 A1
(43) Pub. Date: May 14, 2015

(54) SYSTEM AND METHOD FOR MATCHING AN ANIMAL TO EXISTING ANIMAL PROFILES

(71) Applicant: VISAGE The Global Pet Recognition Company Inc., Vancouver (CA)

(72) Inventors: Philip Rooyakkers, Vancouver (CA); Daesik Jang, Vancouver (CA)

(21) Appl. No.: 14/540,990

(22) Filed: Nov. 13, 2014

Related U.S. Application Data
(60) Provisional application No. 61/904,386, filed on Nov. 14, 2013.

(51) Int. Cl. G06K 9/62; G06F 17/30; G06K 9/00

(52) U.S. Cl. CPC G06K 9/6202; G06K 9/00362; G06F 17/30247; G06F 17/30268
USPC 382/110

(57) ABSTRACT

Systems and methods are described that may be used to match an image of an unknown animal, such as a lost pet, with images of animals that have been registered with an online service. Matching of the images of animals may be done in a two stage process. The first stage determines one or more images based on a classification of the images on the visual characteristics. The second stage determines a degree of matching between the retrieved images and the image to be matched.

### CROSS-REFERENCE TO RELATED APPLICATION

This application claims priority pursuant to 35 USC §119(e) to U.S. Provisional Patent Application Ser. No. 61/904,386 and filed on Nov. 14, 2013, the entirety of which is hereby incorporated by reference herein.

### TECHNICAL FIELD

The current disclosure relates to systems and methods for matching an animal to one or more existing animal profiles, and in particular to matching an image of the animal to one or more images of animal profiles that may be the same animal based on multi-layer category classification of the images and precise matching of resultant facial images.

### BACKGROUND

According to the American Humane Society, approximately 5,000,000 to 7,000,000 animals enter animal shelters annually in the United States. Of these, approximately 3,000,000 to 4,000,000 are euthanized. Shelter intakes are about evenly divided between those animals relinquished by owners to the shelters and those animals that animal control captures. Many of the animals that animal control captures are lost pets. Various techniques exist for locating owners of a lost animal, including identification tags, identification tattoos as well as identification microchips.

An online system for helping to identify owners of lost pets that have been located may require a user to register their pet with the system. The registration process may associate a picture of the pet with owner information. When a person finds a lost pet, a picture of the animal can be captured and submitted to the system, which can identify matching pictures of registered animals using facial recognition techniques. If a match is found, the owner of the lost animal can be notified and the animal returned home.

While facial recognition may be beneficial in identifying potential matches to an image, it may be computationally expensive to perform the facial recognition and comparison on each image stored for registered users. Further, the facial recognition process may result in a number of un-related, or not similar, images being matched. The resultant larger result set may be more difficult for a user to looking to find a matching animal to sort through.

It would be desirable to have an improved, additional and/or alternative approach for matching an animal to one or more existing animal profiles.

### BRIEF DESCRIPTION OF DRAWINGS

These and other features, aspects and advantages of the present disclosure will become better understood with regard to the following description and accompanying drawings, wherein:

FIG. 1 depicts a process for notifying owners if a missing pet is located;

FIG. 2 depicts a method of matching image data to existing pet profiles;

FIG. 3 depicts a process of matching an image of a pet to one or more existing profiles of pets;

FIG. 4 depicts a further method matching image data to existing pet profiles;

FIG. 5 depicts a method for detecting facial components;

FIG. 6 depicts a method of training a multi-layer classifier;

FIG. 7 depicts a method of classifying an image using a multi-layer classifier;

FIG. 8 depicts components of a system for matching an image of an animal with one or more profiles of animals;

FIG. 9 depicts a server environment that may be used in a system for matching an image of an animal with one or more profiles of animals;

FIG. 10 depicts a method for registering a pet;

FIG. 11 depicts a method for identifying a lost pet; and

FIG. 12 depicts a method for reporting pet that has been located.

### DETAILED DESCRIPTION

In accordance with the present disclosure there is provided a method for matching an animal to existing animal profiles comprising receiving an image of the animal to be matched at an animal identification server; determining a classification label of the animal based on visual characteristics of the image and predefined classification labels; retrieving a plurality of animal profiles associated with the determined classification label of the animal; determining a respective match value between image features of the image and image features from each of the retrieved animal profiles.

In at least one embodiment of the method, determining the classification label of the animal comprises using one or more support vector machines (SVM) to associate at least one of a plurality of predefined classification labels with the image based on visual characteristic features of the image.

In at least one embodiment of the method, a plurality of SVMs hierarchically arranged are used to associate the at least one classification label with the image.

In at least one embodiment of the method, the method may further comprise training one or more of the plurality of SVMs.

In at least one embodiment of the method, the method may further comprise calculating the visual characteristic features of the image, wherein the visual characteristic features comprise one or more of color features; texture feature; Histogram of Oriented Gradient (HOG) features; and Local Binary Pattern (LBP) features.

In at least one embodiment of the method, the method may further comprise determining the visual characteristic features of the image that are required to be calculated based on a current one of the plurality of SVM classifiers classifying the image.

In at least one embodiment of the method, the method may further comprise receiving an initial image of the animal captured at a remote device; processing the initial image to identify facial component locations including at least two eyes; and normalizing the received initial image based on the identified facial component locations to provide the image.

In at least one embodiment of the method, normalizing the received initial image comprises normalizing the alignment, orientation and or size of the initial image to provide a normalized front-face view.

In at least one embodiment of the method, receiving the initial image and processing the initial image are performed at the remote computing device.

In at least one embodiment of the method, the method may further comprise transmitting a plurality of the identified facial component locations, including the two eyes, to the server with the initial image.

In at least one embodiment of the method, normalizing the initial image is performed at the server.

In at least one embodiment of the method, retrieving the plurality of animal profiles comprises retrieving the plurality of animal profiles from a data store storing profiles of animals that have been reported as located.

In at least one embodiment of the method, the method may further comprise determining that all of the respective match values between image features identified in the image and image features of each of the retrieved animal profiles are below a matching threshold; retrieving a second plurality of animal profiles associated with the determined classification label of the animal, the second plurality of animal profiles retrieved from a second data store storing animal profiles; and determining a respective match value between image features identified in the image data and image features of each of the retrieved second plurality of animal profiles.

In at least one embodiment of the method, the second data store stores animal profiles that have been registered with the server.

In accordance with the present disclosure there is further provided a system for matching an animal to existing animal profiles comprising at least one server communicatively couplable to one or more remote computing devices, the at least one server comprising at least one processing unit for executing instructions; and at least one memory unit for storing instructions, which when executed by the at least one processor configure the at least one server to receive an image of the animal to be matched at an animal identification server; determine a classification label of the animal based on visual characteristics of the image and predefined classification labels; retrieve a plurality of animal profiles associated with the determined classification label of the animal; determine a respective match value between image features of the image and image features from each of the retrieved animal profiles.

In at least one embodiment of the system, determining the classification label of the animal comprises using one or more support vector machines (SVM) to associate at least one of a plurality of predefined classification labels with the image based on visual characteristic features of the image.

In at least one embodiment of the system, a plurality of SVMs hierarchically arranged are used to associate the at least one classification label with the image.

In at least one embodiment of the system, the at least one memory further stores instructions, which when executed by the at least one processor configure the at least one server to train one or more of the plurality of SVMs.

In at least one embodiment of the system, the at least one memory further stores instructions, which when executed by the at least one processor configure the at least one server to calculate the visual characteristic features of the image, wherein the visual characteristic features comprise one or more of color features; texture feature; Histogram of Oriented Gradient (HOG) features; and Local Binary Pattern (LBP) features.

In at least one embodiment of the system, the at least one memory further stores instructions, which when executed by the at least one processor configure the at least one server to determine the visual characteristic features of the image that are required to be calculated based on a current one of the plurality of SVM classifiers classifying the image.

In at least one embodiment of the system, the at least one memory further stores instructions, which when executed by the at least one processor configure the at least one server to receive an initial image of the animal captured at a remote device; process the initial image to identify facial component locations including at least two eyes; and normalize the received initial image based on the identified facial component locations to provide the image.

In at least one embodiment of the system, normalizing the received initial image comprises normalizing the alignment, orientation and or size of the initial image to provide a normalized front-face view.

In at least one embodiment of the system, the one or more remote computing devices each comprise a remote processing unit for executing instructions; and a remote memory unit for storing instructions, which when executed by the remote processor configure the remote computing device to receive an initial image of the animal captured at the remote computing device; process the initial image to identify facial component locations including at least two eyes; and transmit a plurality of the identified facial component locations, including the two eyes, to the server with the initial image.

In at least one embodiment of the system, retrieving the plurality of animal profiles comprises retrieving the plurality of animal profiles from a data store storing profiles of animals that have been reported as located.

In at least one embodiment of the system, the at least one memory further stores instructions, which when executed by the at least one processor configure the at least one server to determine that all of the respective match values between image features identified in the image and image features of each of the retrieved animal profiles are below a matching threshold; retrieve a second plurality of animal profiles associated with the determined classification label of the animal, the second plurality of animal profiles retrieved from a second data store storing animal profiles; and determine a respective match value between image features identified in the image data and image features of each of the retrieved second plurality of animal profiles.

In at least one embodiment of the system, the second data store stores animal profiles that have been registered with the server.

When an unknown pet, such as a lost dog or cat, is located an image may be captured and submitted to an online service in an attempt to locate an owner of the unknown pet.

The online service may allow an owner to register their pet with the service. When registering, an image of the pet may be associated with contact information of the owner. When the image of a pet that has been located is submitted to the service, it may be compared to the images of registered pets. If a match is found, the owner can be contacted using the associated contact information and the owner can be reunited with the previously lost pet. Additionally, the online service may include functionality allowing an owner of a registered pet to indicate that the pet is lost. By searching only those images of registered pets reported as lost, the computational burden may be reduced; however, if a pet is lost without the owner's knowledge it would not be located in the search, and a wider search of registered pets could be performed.

As described further below, an image of a located pet may be used in a search of registered pet images in order to locate potential matches to the image of the located pet. The search may be performed in two stages. The first stage locates images of registered pets that have similar visual characteristics. The second stage performs a precise matching between the image of the located pet and each of the images of registered pets found to have similar visual characteristics. The first stage of locating images of registered pets that have similar visual characteristics may be performed by first using computer vision techniques to assign one or more classification labels to the located pet image. Each classification label may be one of a plurality of predefined classification labels that group together similar visual characteristics. The assigned classification label, or labels, may be used to retrieve images of registered pets that were assigned the same classification label, or labels, at the time of registration. Once a plurality of registered pet images are retrieved, which will share similar visual characteristics since each has at least one common classification label, the image of the located pet may be matched to each of the images of the registered pets in order to determine a matching between the images. The matching level may be expressed as a value that allows images of registered pets to be ranked with regard to their similarity to the image of the located pet. As such, the searching may determine one or more images of registered pets that match, to some degree, the image of the located pet. Each of the images of registered pets may be associated with respective owner information, such as contact information. Once the matching images of registered pets are determined, various actions are possible, including notifying the owner of the pet.

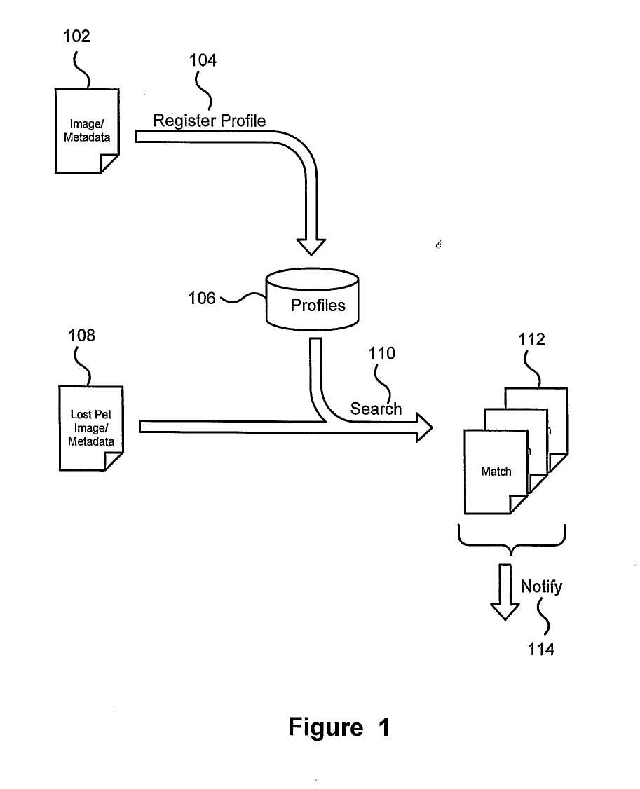

FIG. 1 depicts a process for notifying owners if a missing pet is located. The process 100 includes one or more owners registering their pets with the service. The registration process 104 may include an owner providing an image or images of the pet as well as metadata including owner contact information and information describing the pet. The metadata describing the pet may include information such as dog's name, age, fur color, eye color, breed, height, weight as well as other possible information about the pet. The metadata may also include information on the owner including contact information, geographic information such as common places the pet is, such as cottage locations and home locations, preferences for the service as well as other profile information such as usernames, passwords, etc. A profile is generated from the image and metadata information 102. As described further below, when generating the profile information, the image data may be processed in order to transform it into a normalized version, which may also be stored within the profile. The generated profile is stored in a data source 106, such as a database of profiles.

When another person locates a pet, an image of the pet and associated metadata 108 can be captured and submitted to the online service, which uses the image 108 to search 110 through the profiles 106 for one or more matches 112 between the submitted image 108 and images of registered profiles 106. The metadata submitted by the person finding the pet may simply be contact information such as an email address, telephone number or meeting location. When matches are found, the metadata information of the matching profiles can be used to notify 114 the lost pet's potential owner that the pet may have been located. The submitter's contact information may be provided to the owner in order to allow the two parties to arrange returning the lost and subsequently located pet. If the person locating the pet does not wish to have their contact information shared with the owner, messages can be sent through the service allowing the two parties to arrange a meeting. Additionally or alternatively, returning the pet may be arranged by a 3^{rd} party.

The process 100 of FIG. 1 uses image searching to locate lost pets. It will be appreciated that certain components and features of the service, such as user interfaces and interactions are not described in detail; however, their implementation will be apparent. Further, U.S. patent application Ser. No. 14/029,790, filed Sep. 17, 2013 and incorporated herein by reference describes a system for alerting an owner of a lost animal that could be augmented to incorporate the functionality described further herein.

Although described further below with regard to a system for locating a lost pet, the animal image processing and searching described further below may be used for other applications where matching an image of an animal to an existing profile would be of use. Although described with regard to pets, it is contemplated that the system and methods could also be applied to animals not typically considered as pets.

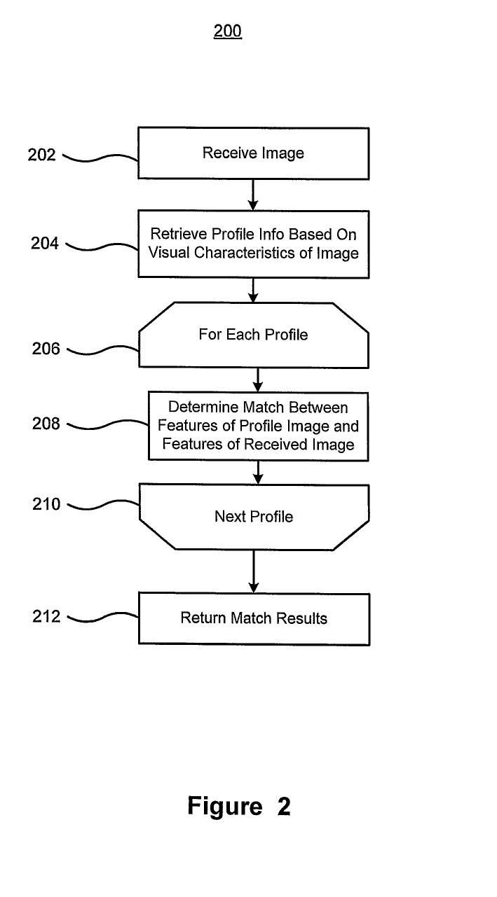

FIG. 2 depicts a method of matching a pet image to existing pet profiles. The pet image may be generated from an image captured of a lost pet that has been located, and allows the located pet to be matched to its associated profile. The associated profile of the located pet will include owner contact information. The method 200 may be performed at a server that provides functionality for alerting an owner of a lost pet that the pet has potentially been located. The method 200 receives an image (202) of the pet that has been located. The image may be received from a remote computing device, such as a personal computer, tablet, mobile phone or other computing device. The received image may be the result of processing a captured image of the pet, for example to normalize the color, size, alignment and orientation of the image. The processing of a captured image may be done at a remote device or at the server. As described further herein, the image may be generated by processing a captured image of the located pet in order to normalize the image to a front-face view having a predefined size. Once the image has been received, it is used to retrieve previously registered pet profiles based on the visual characteristics of the received image of the located pet (204). That is, pet profiles that are associated with images that share similar visual characteristics as the image of the located pet are retrieved.

As described further below, classification labels may be used to determine images of pets that share visual characteristics. Classification labels may be defined that group together pets, or more particular images of pets, having the same visual characteristics. That is, images of pets that look similar would be assigned the same classification label. Additionally, a single image may be assigned one or more classification labels based on the visual characteristics. The image of the located pet may be used to determine a classification label, or labels, for the image of the located pet. The determined classification label or labels may then be used to retrieve existing pet profiles having images that share a common classification label. A pet profile may be associated with a classification label or labels during the registration process, or in an update process to the pet profile. The same process used to determine a classification label or labels of the image of the located pet may also be used to determine a classification label or labels of a pet when the profile is created or updated. As such, images of pets that are assigned the same classification label or labels, whether at the time of registering a pet, or when searching for matching images of pets, may be considered as sharing similar visual characteristics.

Once one or more pet profiles that share similar visual characteristics with the located pet image are retrieved, each profile is processed (206). The processing of each profile may determine a match between features of the image of the profile and features of the image of the located pet (208). Determining the match may result in a numerical value indicative of how closely the two images, or the features of the two images, resemble each other. Once a profile has been processed, the next profile is retrieved (210) and processed accordingly to determine a matching value. Once all of the profiles have been processed, the results of the matching, which will provide an indication as to the degree to which a profile, or more particularly an image of the profile, resembles or matches a received image can be returned (212). A matching threshold may be used to reduce the number of results returned, that is profiles that do not match sufficiently, as indicated by the matching threshold, may not be returned.

The results of the matching may be used to determine the profile that is most likely to be the profile of the located pet. The likely owner of the pet that was located can be contacted and the return of the pet arranged. The communication between the owner and the person who located the pet may be done directly, that is the person who located the pet may be provided with the owner's contact information, or the owner provided with the number of the person who located the pet, and they can subsequently contact each other directly. Additionally, or alternatively, the communication may be facilitated through the pet locating service.

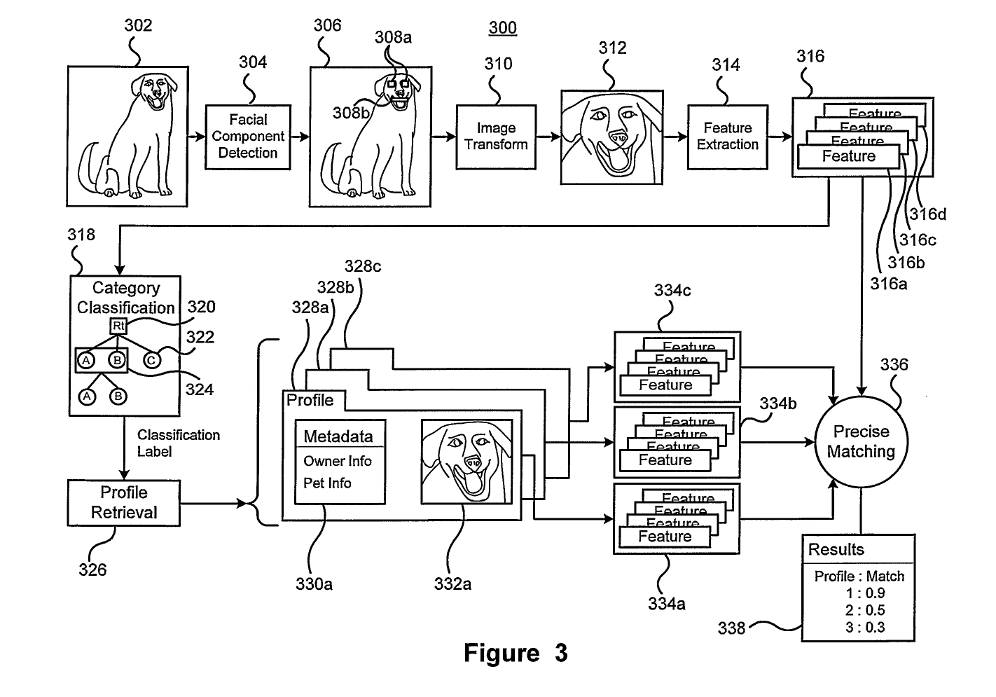

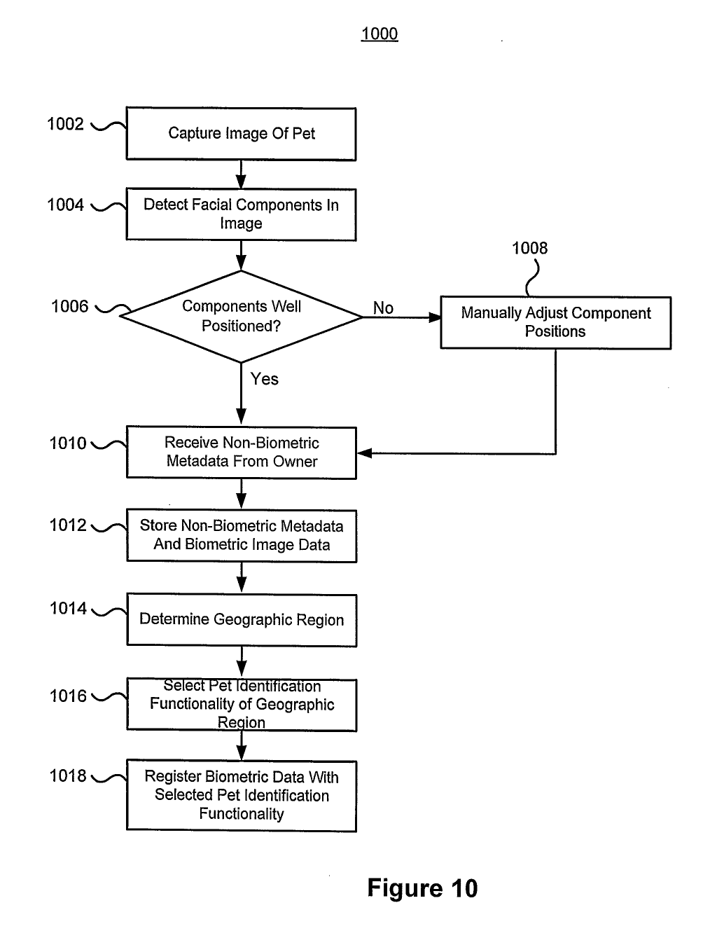

FIG. 3 depicts a process of matching an image of a pet to one or more existing profiles of pets. The process 300 assumes that a number of owners have registered their pets with the locating service. A registration process is described further with regard to FIG. 10. Each of the registered pet profiles includes a biometric image of the pet and metadata which includes at least contact information of the owner but may include further owner information and pet information. A profile may include additional images of the pet; however, the biometric image is an image that is used for searching and matching with other images, such as images of pets that have been located. It is noted that FIG. 3 depicts the pets as being dogs; however, it is contemplated that the pets could be other animals. Further, it is assumed in FIG. 3 that one of the registered pets has been lost by the owner and subsequently located by another person.

The process 300 begins with the person who located the pet capturing an image 302 of the located pet. The image may be captured on the person's smart phone or tablet. Alternatively, a picture may be captured of the located pet and transferred to a computing device and selected as the image. If the image 302 is captured on the person's smart phone, it may be done using a pet finding application on the phone or it may be done using the camera application on the smart phone and subsequently selected in the pet finder application or at a web site that provides the pet finding functionality and allows the image of the located pet to be uploaded. Regardless of how the image 302 is captured, it is processed in order to detect and identify facial components 304. The facial components detected may include for example, the eyes of the pet and the upper lip of the pet. Once the captured image 302 has been processed to identify the facial components, they may be presented to the user. For example, the location of the detected facial components may be displayed graphically to the person who submitted the image of the located pet. The person may be presented with an image 306 of the located pet that is overlaid with the location of the detected facial components, such as the eyes 308a and lip 308b. Presenting the image 306 to the person who located the pet may allow the person to adjust the location of the detected facial components. For example, if the person believes that the upper lip was incorrectly located, or that the detected location could be improved, the person can adjust the location of the upper lip in the displayed image by adjusting the location of the displayed box 308b surrounding the upper lip. Further, not all of the detected facial components may be presented to the user. Rather, certain facial components may only be used internally to determine one or more of the additional facial components. For example, a pet's nose may be used internally in order to locate an upper lip of the pet, and only the pet's eyes and the upper lip may be presented to the user.

Once the location of the facial components has been determined, either automatically or in cooperation with the person who captured the image of the located pet, the locations are used to transform the image. The image transform 310 attempts to normalize the captured image 302 into a standard view to facilitate subsequent searching and matching. The image transform 310 may include adjusting the color of the image, such as by adjusting the white balance, brightness and/or saturation. Further, the image may be adjusted based on the determined locations of the facial components. For example, the captured image 302 may be rotated, scaled and cropped in order to generate an image 312 of a predefined size and having the facial components in a specified alignment and orientation. For example, the image 302 may be scaled, rotated and cropped so that the upper lip is located in the horizontal center of the image 312, the eyes are located above the upper lip and are horizontally even with each other. These requirements are only illustrative and the requirements for producing a normalize image 312 may vary. However, the same process is applied to the biometric images of pet profiles when they are registered. Accordingly, the image transform process 310 attempts to normalize the views of images to a front-face view so that comparisons between images compare the same or similar views.

Once the captured image 302 is transformed into the normalized image 312, features are extracted 314 from the image 312. The feature extraction 314 may extract a plurality of features 316a, 316b, 316c and 316d, referred to collectively as features 316. The extracted features 316 may include color features, texture feature, Histogram of Oriented Gradient (HOG) features, Local Binary Pattern (LBP) features as well as other features that may be useful in subsequent classification and matching. Generally, each of the features 316 may be represented as a vector of numbers. As described below, the extracted features may be used by one or more classifiers, as well as in precisely matching images. However, although FIG. 3 depicts all of the features being extracted at once, it is contemplated that the features used by different classifiers, and matching functionality may extract the features from the image as required.

Once the features 316 have been extracted they may be used by a category classification process 318. The category classification process 318 attempts to assign a classification label to the image 312 based on the one or more of the extracted features 316. As described further below, the category classification process 318 may utilize a hierarchy of classifiers. The classifiers are schematically represented by the rectangles 320 and 324 in FIG. 3. Each classifier 320, 324 attempts to assign a classification label to an image based on the training of the respective classifier. In FIG. 3, the root classifier 320 can assign one of three classification labels A, B, C depicted by circles 322. However, in FIG. 3 it is assumed that during the training of the root classifier 324 a number of images were misclassified. In particular a number of images that should have been classified as ‘A’ were classified as ‘B’ and/or a number of images that should have been classified as ‘B’ were classified as ‘A’. As such, another classifier 324 is used to re-classify any images that the root classifier 320 classified as either ‘A’ or ‘B’. Although only two hierarchical levels of category classifiers are depicted in FIG. 3, it is contemplated that additional hierarchical levels could be included. Further, although described as using a hierarchical arrangement of classifiers, it may be possible to use a single classifier that is capable of correctly assigning classification labels to images with a desired degree of confidence.

Regardless of how the category classification 318 is accomplished, it determines a classification label, or possible a category of classification labels as described further below, for the image 312 based on at least one of the extracted features 316. The assigned classification label or labels may then be used to retrieve 326 one or more pet profiles associated with at least one common classification label. When a pet is registered with the service, an image of the pet is processed in a similar manner as described above with regard to processing the located pet image 302. As such, each pet profile is associated with a classification label, or category of classification labels, based on the biometric image of the pet profile.

The profile retrieval 326 retrieves one or more profiles 328a, 328b, 328c (referred to collectively as profiles 328) that are each share at least one of the determined classification label or labels. Each profile comprises a biometric image 332a and metadata 330a (only the biometric image and metadata for profile 328a are depicted). The biometric image is used in the searching and matching of images. The metadata 330a may include owner information including contact information as well as pet information such as eye color, fur color, size, breed information, name, distinguishing features etc. The metadata may also include geographic information describing the geographic area the pet is typically in, such as the city or area of the owner's home, the city or area of the owner's cottage as well as the city or area of a caretaker's home. Once the profiles 328 sharing a common classification label with the processed image 312 are retrieved, each biometric image of the profiles is processed. The processing of each biometric image extracts features 334a, 334b, 334c (referred to collectively as features 334) used for determining a similarity match between the respective biometric image of the profiles 334 and the image 312 of the located pet. The features 334 extracted from the biometric images may be the same features 316 extracted from the image 312 of the located pet, or they may be different features. The features 334 extracted from the biometric image of the profiles may be extracted as the profiles are processed or they may be extracted during the registration of the pet and stored with the profile.

A precise matching process 336 determines a matching value between features 316 extracted from the image 312 of the located pet and the features extracted from each of the biometric images of the pet profiles 328. Although depicted as utilizing the same features for the precise matching 336 and the category classification 318 it is contemplated that different features may be used for each process. The precise matching determines a matching value that provides an indication of how similar the compared features are, and as such, how similar the biometric image of the profiles are to the image 312 of the lost pet. The precise matching process provides results 338 that can be ordered to determine which profiles are most likely the profile of the located pet. As depicted in FIG. 3, the matching value may be a value between 0 and 1, where 0 indicates that there is no similarity between two images or features of images and 1 indicating that the images or features of images are the same. As depicted, the results 338 indicate that one profile, namely profile ‘1’ was matched to the located pet image with a value of 0.9. Similarly, the results depicts that profile ‘2’ has a matching value of 0.5 and profile ‘3’ has a matching value of 0.5. Given these results, and in particular the relatively high matching value of profile ‘1’ and the comparatively low matching values of the other profiles, the profile ‘1’ may be selected to be the profile of the located pet. If however, the other profiles also had comparatively good matching values, the results could be further filtered, for example by comparing pet information in the profile with pet information submitted by the person who located the pet. Additionally or alternatively, the results returned may provide a plurality of profiles instead of a single profile.

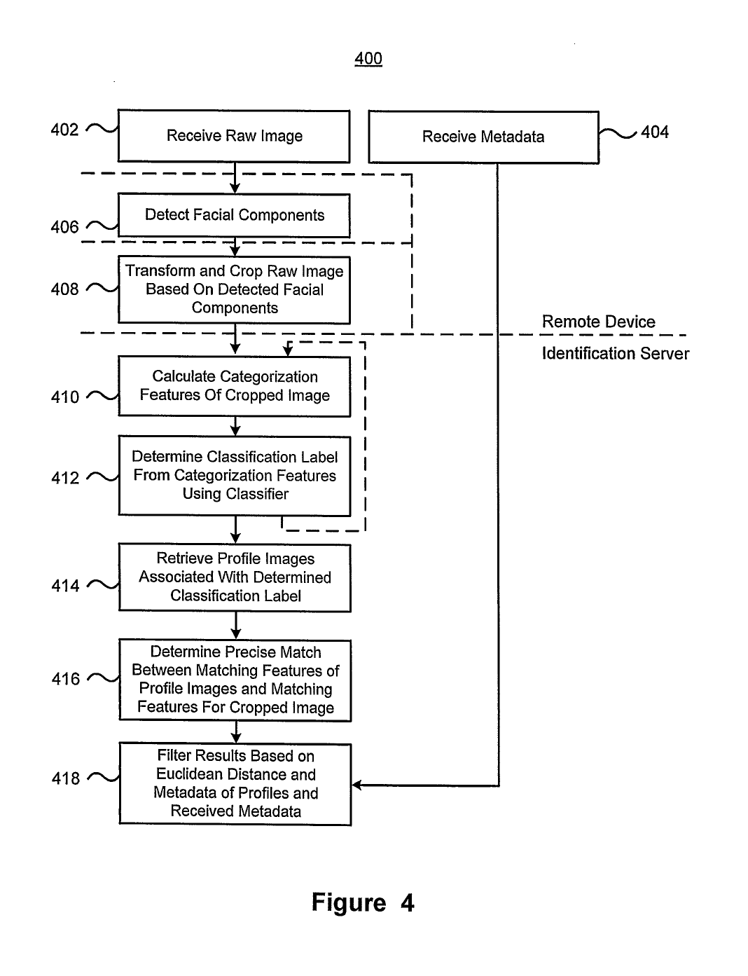

FIG. 4 depicts a further method matching image data to existing pet profiles. The method 400 depicts steps that may occur when a lost pet is located. As depicted, some of the steps may be carried out at a remote device, such as a smart phone, tablet or other computing device of a person who located the lost pet. As depicted by the dashed lines, the particular steps carried out at the remote device may vary. The remote device may capture or receive a raw image of the pet and transmit the raw image to a server for further processing. Alternatively, the remote device may capture the raw image, and detect the location of facial components in the image and then submit the image and facial component location information to the server. Further still, the remote device may capture the image, determine the location of facial components and transform and crop the image based on the location of the facial components, and then submit the transformed and cropped image to the server.

Regardless of where the specific steps are performed, the method begins with receiving a raw image (402) of the dog that has been located. The raw image is considered to be an image that has not been processed by the method to generate a standard front-face view. The raw image may be captured by a phone camera or other camera. When the image is captured, the person who located the pet may also input metadata (404). The metadata may include information about the pet, such as fur color, eye color, size, breed information as well as the geographic location the pet was located. The metadata may also include contact information on the person who located the pet.

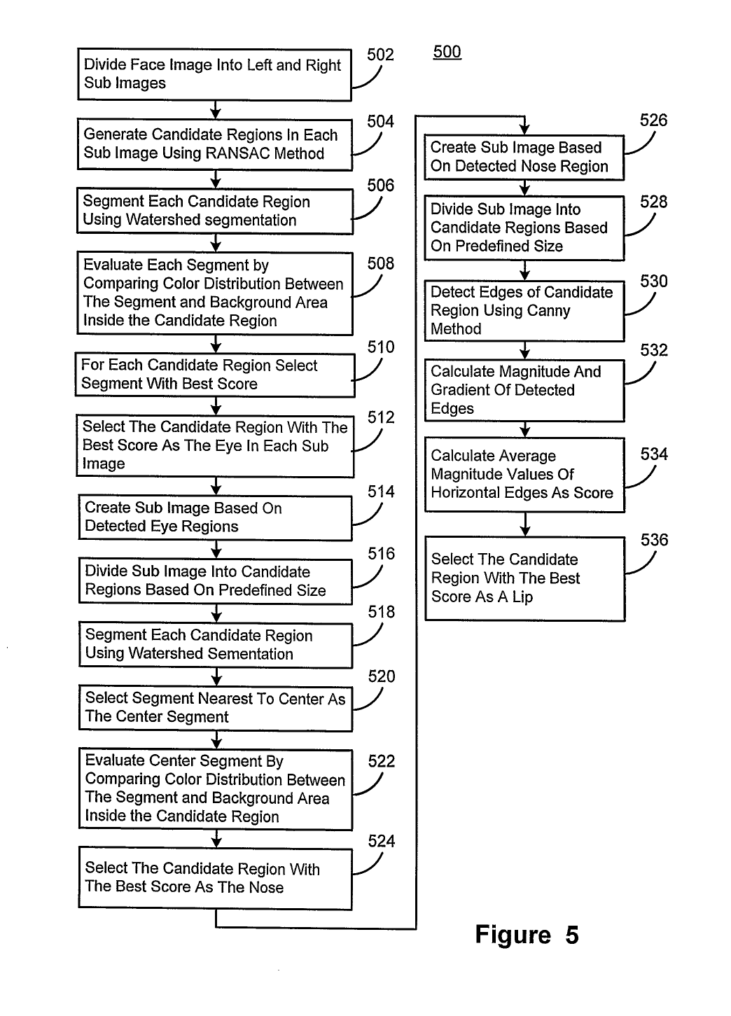

Once the raw image has been received, facial components are detected within the image (406). The detection of the facial components may be performed using various image processing techniques. One possible method is described in further detail below with reference to FIG. 5. The detected facial components may include the location of the eyes and upper lip. Once the facial components are detected, the image is transformed based on the detected facial components (408). The image may be scaled, rotated and cropped in order to orient the detected facial components in a desired alignment and orientation. The transformation of the image provides a standard view for comparing images. Further, the transformation of the image may include adjusting the color, brightness and saturation of the image.

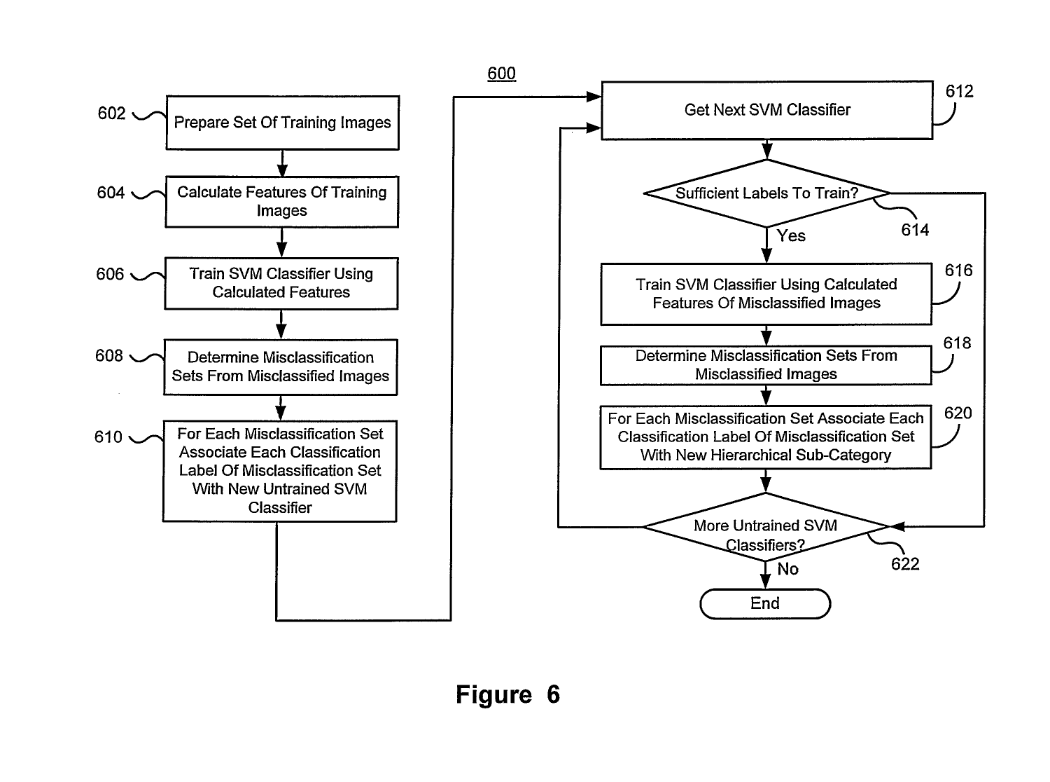

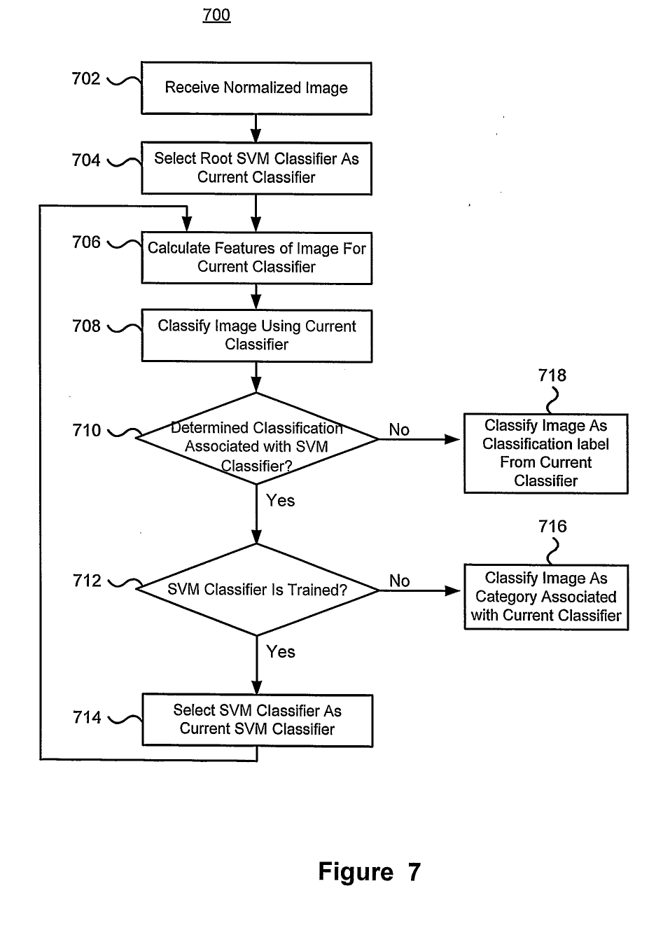

Once the image has been transformed and cropped, features that are used in classifying the visual characteristics of the image are calculated (410). The features that are used in the classification process may vary depending on the classification process. The selection of the features may be a results-oriented process in order to select the features that provide the best classification of images. The features may be selected experimentally in order to provide a set of features that provides the desired classification. Once the features are calculated, a classification label or labels are determined for the image using the calculated features and a classifier (412). The classification process may be a hierarchical process and as such, the classification label determined by the classifier may be associated with another lower classifier. Accordingly, the classification label is associated with another classifier, the method re-classifies the image using the lower classifier. If the classification label is associated with a lower classifier, the method may calculate the features used by the lower classifier (410) and then classify the image using the newly calculated features and the lower classifier (412). This recursive process may continue until there are no more classifiers to use, at which point the image will be associated with a classification label, or possibly a plurality of labels if the last classifier could not assign an individual label to the image. The recursive category classification described above may be provided by a multi-layered classifier as described further below with reference to FIGS. 6 and 7.

Once the classification label or labels are determined they are used to retrieve profiles that are associated with a common classification label (414). That is, if the classification process classifies the image with two classification labels ‘A’ and ‘B’, profiles that are associated with either of these labels, for example, ‘A’; or ‘B’; or ‘A,C’ may be retrieved

The profiles may be retrieved from a collection of profiles of pets that have been indicated as being lost, from the entire collection of registered profiles, or from other sources of pet profiles. Further, the profiles may be filtered based on geographic information provided in the received metadata and pet profile. Once the profiles are retrieved, the biometric image, or the features calculated from the biometric image, in each profile is compared to that of located pet in order to determine a matching degree indicative of a similarity between the two. The matching may determine a Euclidean distance between one or more feature vectors of the biometric image of the pet profile and the same one or more feature vectors of the image of the located pet (416).

Once the degree of matching is determined for each profile, the profiles may be filtered based on the determined Euclidean distance as well as other metadata in the profiles and received metadata (418). The results may be filtered so that only those results are returned that have a degree of matching above a certain threshold. For example, only those profiles that were determined to be within a certain threshold distance of each other may be returned. Additionally or alternatively, a top number of results, for example the top 5 matches, or a top percentage of results may be returned. Further still, the results may be filtered based on the metadata information. For example, a large dog and a small dog may have similar facial features and as such a match of their images may be very high, however the metadata would identify the dogs as not a good match. The metadata information may include breed information, height, weight, fur color and eye color. Once a number of potential matching profiles have been determined the owner of the dog may be notified using the notification information in the profile. Alternatively, information from the profile may be presented to the user that located the dog in order to identify which dog they located.

FIG. 5 depicts a method for detecting facial components. The method 500 detects eyes, nose and upper lip location in an image. The method receives a face image and generates two sub-images for detecting the left and right eyes (502). The two sub-images are generated by dividing the face image in half vertically to provide a left sub-image and a right sub-image. Each sub-image is processed in the same manner. Candidate regions are generated for each sub-image using the RANSAC method (504).

Once the candidate regions for each sub-image are determined, each region is segmented using watershed segmentation (506). Each segment is evaluated by comparing the color distribution between the segment and background area inside the candidate region (508) in order to generate a score for the segment. For each candidate region, the segment with the best score is selected as the score for the candidate region (510) and the candidate region with the best score is selected as the region of the eye in each sub image (512).

Once the location of the eyes have been determined, the nose is located. Another sub-image is created for detecting the nose. The sub image is created based on the location of the eyes (514). The sub-image is divided into candidate regions based on a predefined size (516) and each candidate region segmented using watershed segmentation (518). The predefined size may be determined experimentally in order to provide desired sensitivity to detecting the nose. For each candidate region, the segment nearest to the center of the segment is selected as the center segment (520). The center segment is evaluated by comparing the color distribution between the segment and the background area inside the candidate region (522). The candidate region with the best center segment score is selected as the nose region (524).

Once the location of the nose has been determined, the upper lip is located. Another sub-image is created for detecting the upper lip. The sub-image is created based on the location of the nose (526). The sub-image is divided into candidate regions based on a predefined size (528) and the edges of each candidate region are detected using the Canny method (530). Once the edges are detected, the magnitude and gradient of the edges are calculated (532) and average magnitude values of the horizontal edges are calculated and used as scores for the candidate regions (534). The candidate region with the best score is selected as the upper lip region (536).

FIG. 6 depicts a method of training a multi-layer classifier. As described above, the searching process for matching profiles uses a categorization process to assign a classification label to an image. The categorization process may be implemented by a number of hierarchically arranged Support Vector Machines (SVMs). The number of levels of SVMs in the hierarchy may depend upon the number of classification labels defined for the root SVM as well as how well the root SVM assigned the labels to images.

The multi-layer classifier comprises a root SVM classifier that is trained to assign one of a plurality of classification labels to an image. However, during training of the root SVM classifier it may be determined that an image that should have been assigned one classification label, for example ‘A’, was assigned an incorrect classification label, for example ‘13’. In such a case, and as described further below, a new SVM classifier is associated with the classification labels ‘A’ and ‘B’ from the root SVM classifier so that any images classified with label ‘A’ or ‘B’ from the root SVM classifier will be re-classified using the lower level of classifier. This hierarchical arrangement of SVM classifiers allows images of pets to be recursively classified until they are assigned a classification label from one or the plurality of predefined classification labels.

The method 600 of generating and training a multi-layer classifier begins with preparing a set of training images (602) of different pets. The training set may comprise a large number of images depicting numerous different pets. For example the training set may comprise 1000 images of different dogs. The 1000 images may be grouped together into 100 different groups that each share similar visual characteristics. Each of the 100 groups may have 10 training images in it. The above numbers are given only as an example, and additional or fewer training images may be used, with additional or fewer groups and differing numbers of images in each group. The set of training images may be prepared by processing each image to generate a normalized front-face view of the image as described above. In addition to normalizing the view of each image, each image is assigned to a group having a classification label. Accordingly, the training set will comprise a number of normalized front-face views each of which has been assigned a classification label from a number of predefined classification labels. Assigning the classification labels to the images is done by a human.

Once the training set is prepared, the features used by the root SVM classifier are calculated for each of the training images (604) and the features and assigned classification labels are used to train the root SVM classifier (606). During the training process the root SVM classifier may misclassify images. That is an image that was classified by a human as ‘A’ may be classified by the root SVM as ‘B’. These misclassifications provide a misclassification pair of the classification label assigned by the human and the classification label assigned by the root SVM. Each of these misclassifications is collected into misclassification sets and the classification labels of the misclassification set are associated with a new untrained SVM classifier (610). Multiple misclassification pairs that share common classification labels may be grouped together into a single misclassification set. When the root SVM classifier assigns one of these classification labels to an image, it will be further classified using the next SVM classifier in the hierarchy. Once the root SVM is trained, there will be a number of misclassification sets and as such a number of new untrained SVM classifiers located below the root SVM in the hierarchy.

The training process recursively trains each of the untrained SVM classifiers. Each time an untrained SVM classifier is trained, it may result in generating a new lower level of the hierarchy of the SVMs. Once a SVM classifier has been trained, the method gets the next SVM classifier to train (612). In order to train a SVM classifier there must be a at least minimum number of classification labels in the set. It is determined if there are enough classification labels in the misclassification set to train the SVM classifier (614). The images used to train a SVM classifier, other than the root SVM classifier, will be those images that were misclassified by the higher level SVM classifier. As such, if only a single image was misclassified, there would not be sufficient classification labels to train the new SVM classifier. The number of classification labels required to train a SVM may be set as a threshold value and may vary. If there are sufficient classification labels to train the SVM classifier (Yes at 614), the SVM classifier is trained using calculated features from the misclassified images of the higher classifier (616). The training of the SVM classifier may misclassify images and the misclassified image sets are determined (618). For each misclassified set a new lower untrained SVM classifier is associated with each of the misclassified labels (620). The method may then determine if there are any more untrained SVM classifiers (622), and if there are (Yes at 622), the method gets the next SVM classifier and trains it. If there are no further SVMs to train (No at 622) the training process finishes.

The training process described above may be done initially to provide a trained multi-layer classifier. Once the multi-layer classifier has been trained as described above, it can be partially trained based on images submitted for classification. The partial training assigns a classification label to an image, and then uses the image and assigned classification label to retrain the SVM classifier.

FIG. 7 depicts a method of classifying an image using a multi-layer classifier. The multi-layer classifier may comprise a plurality of hierarchically arranged Support Vector Machines that have been trained to assign one of a predefined number of classification labels to images. The training of the multi-layered classifier was described above with reference to FIG. 6. The multi-layer classifier may receive an image that has been processed in order to normalize the view of the image. The view can be normalized by detecting the location of the facial components and transforming the image to adjust the location of these features. The image may be rotated, scaled and cropped to a predefined size, with the facial components in a predefined alignment and orientation.

Further, the normalized image may be processed in order to correct color variations by performing white balance correction.

The method 700 begins with receiving a normalized image (702). The image is processed to calculate features used by the classifier. Each classifier of the multi-layer classifier may utilize different features of the image. All of the features used by all classifiers of the multi-layer classifier may be calculated at the outset of the classification. Alternatively, the features used by the individual classifiers may be calculated when needed. The multi-layer classifier comprises a number of hierarchically arranged SVM classifiers. The classification begins with selecting the root SVM classifier as the current SVM classifier (706). The current SVM classifier classifies the image using the calculated features (708). As a result of the classification, the image will be assigned a classification label, which the current SVM classifier was trained on. It is determined if the there is an SVM classifier associated with a group of classification labels including the classification label assigned by the previous SVM classifier (710). If the assigned classification label is part of a group or category of classification labels associated with a lower SVM classifier (Yes at 710) it is determined if the SVM classifier associated with the category or group of classification labels has been trained (712). If the SVM classifier associated with the category or group of classification labels has been trained (Yes at 712), it is selected as the current SVM classifier (714) and used to further classify the image (708). If the SVM classifier has not been trained (No at 712), then the image is classified as the determined category (716) of the untrained SVM classifier. That is, the image is classified as the category or group of classification labels that the untrained SVM classifier is associated with. If the classification label determined by the SVM classifier is not associated with a further SVM classifier (No at 710), the image is assigned the determined classification label (718). As previously described, once a classification label or category of classification labels is assigned to an image, one or more profiles may be determined that are associated with at least one of the classification labels of the classification results. If required, images from the pet profiles may be precisely matched with the image of the located pet.

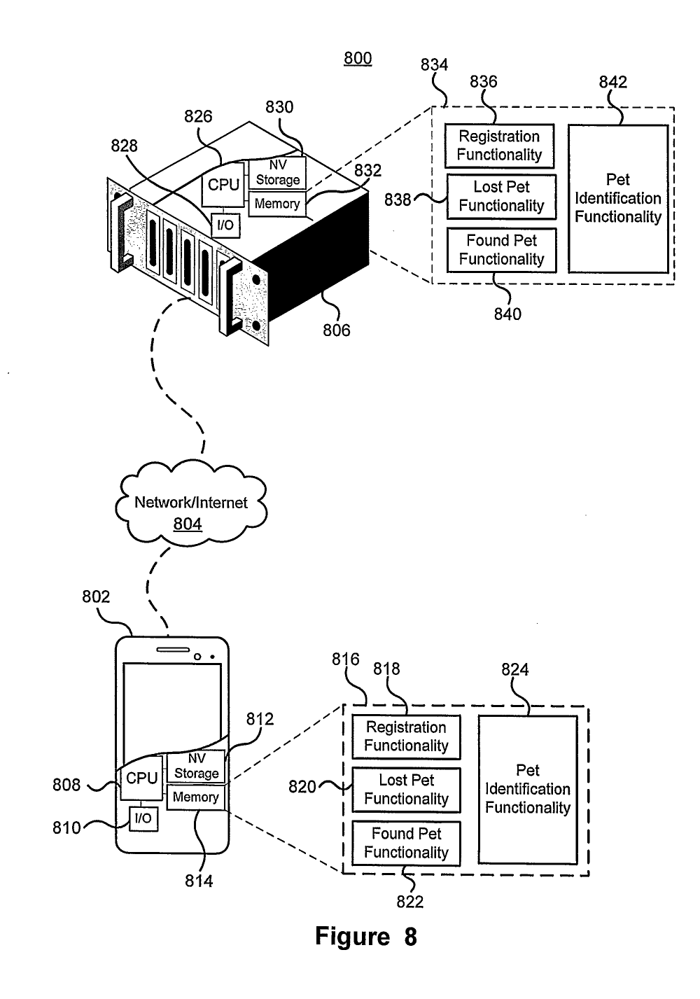

FIG. 8 depicts components of a system for matching an image of an animal with one or more profiles of animals. The system may be used in providing a system for alerting an owner of a lost pet that someone has located the pet. The system 800 comprises a remote computing device 802. Although depicted as a smart phone, the remote computing device 802 may comprise other devices, such as a tablet, laptop desktop or other computing devices. The remote device 802 communicates with a server computing device 806 via a network 804 such as the Internet. Although depicted as a single network, it will be appreciated that the communication between the remote computing device 802 and the server 806 may be provided by a number of interconnected networks, including both wired and wireless networks.

The remote computing device 802 comprises a central processing unit (CPU) 808 for executing instructions. A single input/output interface 810 is depicted, although there may be multiple I/O interfaces. The I/O interface allows the input and/or output of data. Examples of output components may include, for example, display screens, speakers, light emitting diodes (LEDs), as well as communication interfaces for transmitting data. Examples of input components may include, for example, capacitive touch screens, keyboards, microphones, mice, pointing devices, camera as well as communication interfaces for receiving data.

The remote computing device 802 may further comprise non volatile (NV) storage 812 for storing information as well as memory 814 for storing data and instructions. The instructions when executed by the CPU 808 configure the remote computing device 802 to provide various functionality 816. The provided functionality may include registration functionality 818 for registering pets with the pet matching service. The functionality may further comprise lost pet functionality 820 for indicating that a registered pet has been lost. The functionality may further comprise located pet functionality 822 for submitting information of a pet that has been located. The functionality may further comprise pet identification functionality 824 for use in identifying facial components in an image, transforming images, assigning a classification label to an image as well as determining matching values between images.

Similar to the remote computing device 802, the server 806 comprises a central processing unit (CPU) 826 for executing instructions. A single input/output interface 828 is depicted, although there may be multiple I/O interfaces. The I/O interface allows the input and/or output of data. Examples of output components may include, for example, display screens, speakers, light emitting diodes (LEDs), as well as communication interfaces for transmitting data. Examples of input components may include, for example, capacitive touch screens, keyboards, microphones, mice, pointing devices, camera as well as communication interfaces for receiving data.

The server 806 may further comprise non volatile (NV) storage 830 for storing information as well as memory 832 for storing data and instructions. The instructions when executed by the CPU 826 configure the server 806 to provide various functionalities 834. The provided functionality may include registration functionality 836 for registering pets with the pet matching service. The functionality may further comprise lost pet functionality 838 for indicating that a registered pet has been lost. The functionality may further comprise located pet functionality 840 for submitting information of a pet that has been located. The functionality may further comprise pet identification functionality 842 for use in identifying facial components in an image, transforming images, assigning a classification label to an image as well as determining matching values between images.

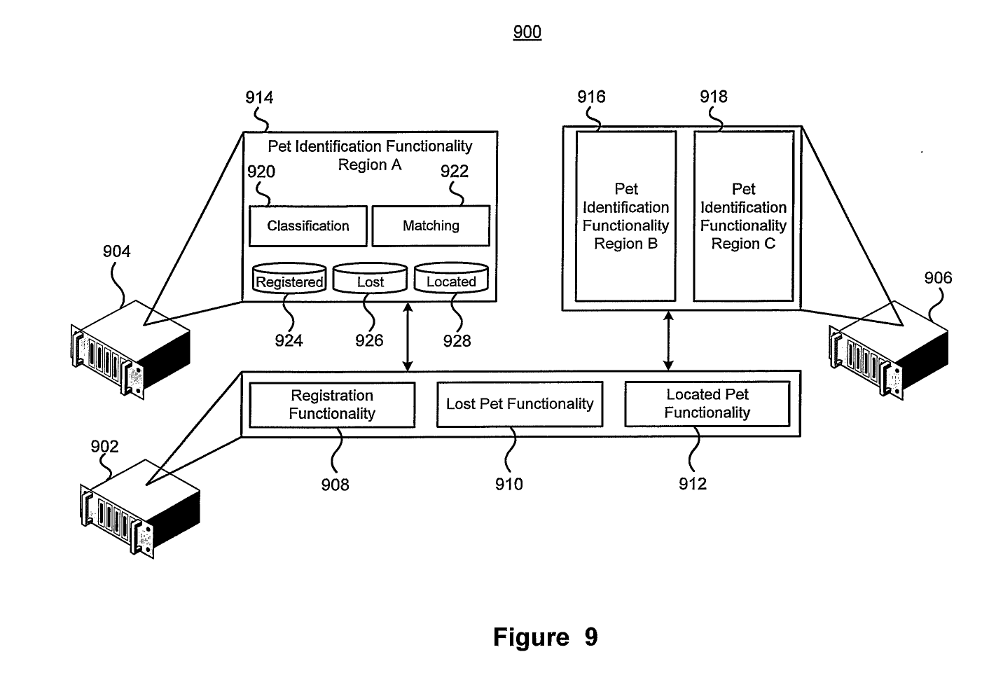

As described above, both the remote computing device 802 and the server 806 include functionality for registering pets, functionality for indicating a pet as lost, functionality for indicating a pet has been located as well as pet identification functionality. The functionality on the server and remote computing device may cooperate in order to provide functionality described above and in further detail below. FIG. 8 depicts the server 806 as being provided by a single server. As depicted further below with regard to FIG. 9, the functionality may be provided by a plurality of servers.

FIG. 9 depicts a server environment that may be used in a system for matching an image of an animal with one or more profiles of animals. The server environment 900 may be used as the server 806 described above with reference to FIG. 8. The server environment 900 comprises a number of servers 902, 904, 906 that provide various functionalities. The server 902 is depicted as providing registration functionality 908, lost pet functionality 910 and located pet functionality 912. The server 902 may act as a front end between a remote computing device and servers 904, 906 that provide pet identification functionality. The pet identification functionality provided by the servers 904, 906 may provide pet identification functionality for different geographic regions. As depicted pet identification functionality 914 may be provided for a first geographic region A, second pet identification functionality 916 may be provided for a second geographic region B and third pet identification functionality 918 may be provided for a third geographic region C. The registration functionality 908, lost pet functionality 910 and located pet functionality 912 may receive requests from remote computing devices and pass the requests on to pet identification functionality for the appropriate region.

FIG. 9 depicts functionality provided by the pet identification functionality 914. Although the functionality is depicted only for pet identification functionality 914, similar functionality would be provided by pet identification functionality 916, 918. The pet identification functionality 914 may comprise classification functionality 920 and matching functionality 922. Additionally, the pet identification functionality may store profiles of registered pets 924, as well as information on animals that were reported as lost 926 and information on animals that were reported as located.

FIGS. 8 and 9 depicted various components that provide functionality for registering pets, identifying lost pets as well as reporting pets that have been located. The functionality provided by the components, such as the remote computing device and server or servers, may implement various methods, including a method for registering a pet, a method for identifying a lost pet and a method for reporting pet that has been located.

FIG. 10 depicts a method for registering a pet. The method 1000 begins with a pet owner capturing an image of a pet (1002). Facial components are detected in the image (1004) and the detected facial components may be displayed. The owner of the pet may review the displayed location of the facial components and determine if the components are well positioned (1006). If the components are not well positioned (No at 1006), the positions of the detected facial components may be manually adjusted (1008). Once the locations of the facial components are manually adjusted, or if the components were well positioned (Yes at 1006), non-biometric metadata may be received from the owner (1010). Although depicted as receiving the non-biometric metadata after receiving the biometric data, it is possible to receive the non-biometric data before, after or in parallel with receiving the biometric data. The metadata may include both owner information as well as pet information as described above. Once the biometric image and non-biometric metadata is received it can be stored in a pet profile (1012). A geographic region may be determined from the metadata (1014). The geographic region may be used to select pet identification functionality to use (1016). Once the geographic has been selected, the biometric data of the profile may be registered with the selected functionality (1018) so that it is available for searching when a pet is lost or located. When registering the biometric data with the pet identification functionality, it may be stored in a store of profiles or biometric data of the registered pets. Further, the registration may classify the image using the multi-layer classifier in order to assign a classification label to the image. The biometric data may be used to partially retrain the multi-layered by training the multi-layered classifier with the biometric data once it has been assigned a classification label or labels by the multi-layer classifier.

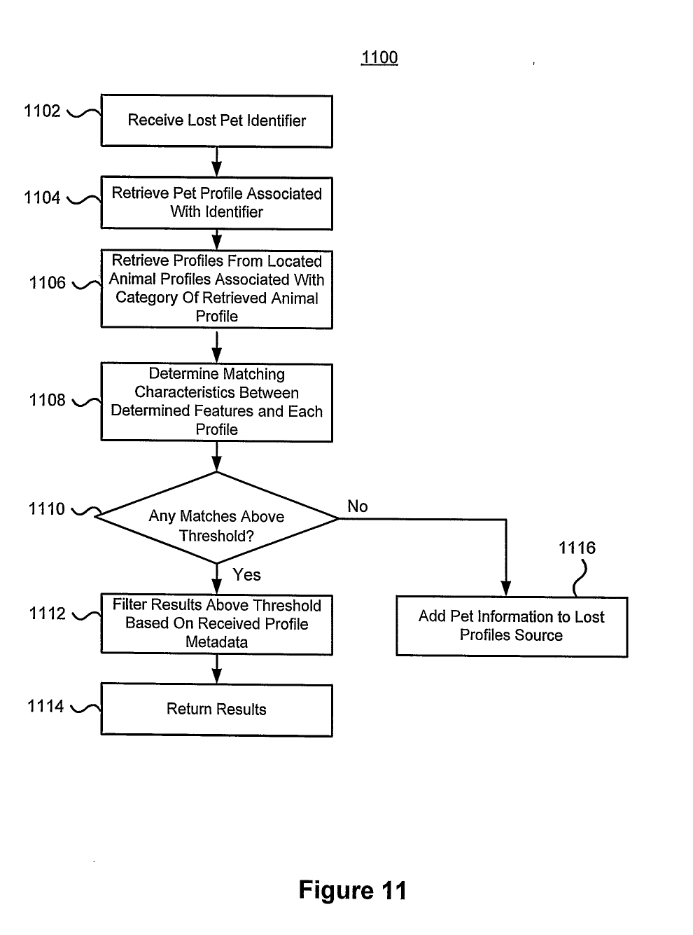

FIG. 11 depicts a method for identifying a lost pet. The method 1100 begins with receiving a pet identifier (ID) and an indication that the pet has been lost (1102). The indication may be provided by the remote computing device. When the indication of the lost pet is received, it is used to retrieve a pet profile associated with the pet ID (1104). Once the pet profile associated with the lost pet ID is retrieved, pet profiles having at least one classification label in common with the lost pet ID profile can be retrieved from a store of profiles of pets that have been located (1106). Once the located profiles are retrieved, each is matched against the biometric data of the profile of the lost pet (1108) and it is determined if any of the matches are above a threshold (1110). If none of the matches are above a matching threshold, then the pet indicated as lost has not already been reported as being located and so the lost pet profile is added to the lost pet profile store (1116). If one or more of the matches is above a match threshold (Yes at 1110), then the results above the match threshold may be filtered based on the metadata. The filtering may filter the results based on, for example a size of the pet, eye color of the pet, fur color of the pet, or other pet information suitable for filtering results. Once the results are filtered they may be returned (1114) and presented to the owner of the lost pet.

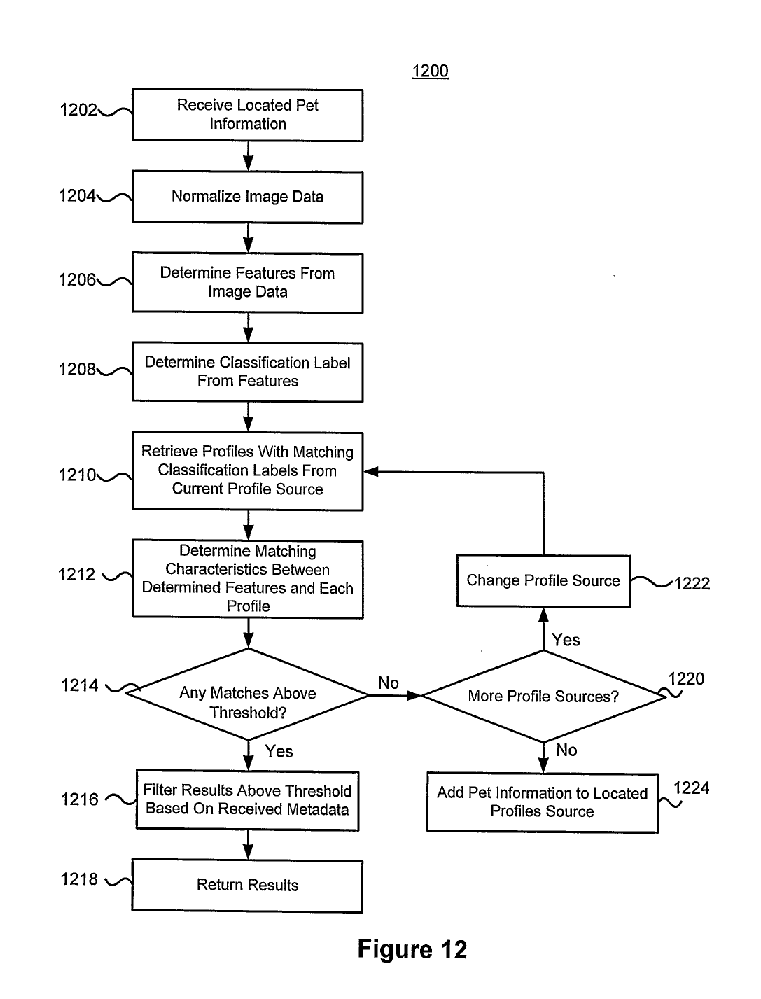

FIG. 12 depicts a method for reporting pet that has been located. The method 1200 begins with receiving information of a located pet (1202). The information may include an image of the pet captured by the person who located the lost pet as well as additional metadata. The metadata may include information about the person who located the lost pet including for example contact information. The metadata may further include information about the animal, such as eye color, fur color, size, breed information as well as other information. The captured image may be normalized (1204). The normalization may normalize the color of the image as well as the alignment, orientation and size of the image. Normalizing the alignment, orientation and size may include identifying the location of facial components in the image and rotating, transforming and/or cropping the image based on the located facial components. Features used in classifying an image may be calculated from the normalized image (1206) and the features are used to determine a classification label or labels of the image (1208). The classification label or labels are used to retrieve pet profiles from a current profile source that are associated with the same classification label (1210). For each of the retrieved profiles, a matching between the image features and each profile is determined (1212) and it is determined if any of the determined matches are above a specified matching threshold (1214). If one or more of the matches is above a matching threshold (Yes at 1214), the profiles may be returned and the results filtered further based on received metadata such as eye color, fur color, size, etc. (1216) and the filtered results returned (1218). If however, none of the matches are above a matching threshold (No at 1214), it is determined if there are any more sources of pet profiles to search (1220). If there are more profile sources to search (Yes at 1220), the profile source is changed (1222), and profiles retrieved based on the classification label (1210). For example, the first source may be the lost pet profile source and if a match is not found in the lost pet profile source, then the source may be changed to another source such as the source of all registered profiles. Once there are no more profile sources (No at 1220) the located pet information is added to the located profile source (1224), which is searched when lost animals are reported.

As described above, a two-stage approach to searching for matching images of animals may be used in order to alert owners of a lost pet if the pet is located by someone else. In addition to system of altering pet owners, the animal matching process described above may be advantageously applied to other applications.

Although the above discloses example methods, apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skills in the art will readily appreciate that the examples provided are not the only way to implement such method and apparatus. For example, the methods may be implemented in one or more pieces of computer hardware, including processors and microprocessors, Application Specific Integrated Circuits (ASICs) or other hardware components.

The present disclosure has described various systems and methods with regard to one or more embodiments. However, it will be apparent to persons skilled in the art that a number of variations and modifications can be made without departing from the teachings of the present disclosure.

What is claimed is:

1. A method for matching an animal to existing animal profiles comprising:
receiving an image of the animal to be matched at an animal identification server;
determining a classification label of the animal based on visual characteristics of the image and predefined classification labels;
retrieving a plurality of animal profiles associated with the determined classification label of the animal;
determining a respective match value between image features of the image and image features from each of the retrieved animal profiles.

2. The method of claim 1, wherein determining the classification label of the animal comprises:
using one or more support vector machines (SVM) to associate at least one of a plurality of predefined classification labels with the image based on visual characteristic features of the image.

3. The method of claim 2, wherein a plurality of SVMs hierarchically arranged are used to associate the at least one classification label with the image.

4. The method of claim 3, further comprising training one or more of the plurality of SVMs.

5. The method of claim 2, further comprising:
calculating the visual characteristic features of the image,
wherein the visual characteristic features comprise one or more of:
color features;
texture features;
Histogram of Oriented Gradient (HOG) features; and
Local Binary Pattern (LBP) features.

6. The method of claim 5, further comprising:
determining the visual characteristic features of the image that are required to be calculated based on a current one of the plurality of SVM classifiers classifying the image.

7. The method of claim 1, further comprising:
receiving an initial image of the animal captured at a remote device;
processing the initial image to identify facial component locations including at least two eyes; and
normalizing the received initial image based on the identified facial component locations to provide the image.

8. The method of claim 7, wherein normalizing the received initial image comprises:
normalizing the alignment, orientation and or size of the initial image to provide a normalized front-face view.

9. The method of claim 7, wherein receiving the initial image and processing the initial image are performed at the remote computing device.

10. The method of claim 9, further comprising:
transmitting a plurality of the identified facial component locations, including the two eyes, to the server with the initial image.

11. The method of claim 9, wherein normalizing the initial image is performed at the server.

12. The method of claim 1, wherein retrieving the plurality of animal profiles comprises:
retrieving the plurality of animal profiles from a data store storing profiles of animals that have been reported as located.

13. The method of claim 12, further comprising:
determining that all of the respective match values between image features identified in the image and image features of each of the retrieved animal profiles are below a matching threshold;
retrieving a second plurality of animal profiles associated with the determined classification label of the animal, the second plurality of animal profiles retrieved from a second data store storing animal profiles; and
determining a respective match value between image features identified in the image data and image features of each of the retrieved second plurality of animal profiles.

14. The method of claim 13, wherein the second data store stores animal profiles that have been registered with the server.

15. A system for matching an animal to existing animal profiles comprising:
at least one server communicatively couplable to one or more remote computing devices, the at least one server comprising:
at least one processing unit for executing instructions; and
at least one memory unit for storing instructions, which when executed by the at least one processor configure the at least one server to:
receive an image of the animal to be matched at an animal identification server;
determine a classification label of the animal based on visual characteristics of the image and predefined classification labels;
retrieve a plurality of animal profiles associated with the determined classification label of the animal;
determine a respective match value between image features of the image and image features from each of the retrieved animal profiles.

16. The system of claim 15, wherein determining the classification label of the animal comprises:
using one or more support vector machines (SVM) to associate at least one of a plurality of predefined classification labels with the image based on visual characteristic features of the image.

17. The system of claim 16, wherein a plurality of SVMs hierarchically arranged are used to associate the at least one classification label with the image.

18. The system of claim 17, wherein the at least one memory further stores instructions, which when executed by the at least one processor configure the at least one server to train one or more of the plurality of SVMs.

19. The system of claim 16 wherein the at least one memory further stores instructions, which when executed by the at least one processor configure the at least one server to:
calculate the visual characteristic features of the image, wherein the visual characteristic features comprise one or more of:
color features;
texture features;
Histogram of Oriented Gradient (HOG) features; and
Local Binary Pattern (LBP) features.

20. The system of claim 19, wherein the at least one memory further stores instructions, which when executed by the at least one processor configure the at least one server to:
determine the visual characteristic features of the image that are required to be calculated based on a current one of the plurality of SVM classifiers classifying the image.

21. The system of claim 15, wherein the at least one memory further stores instructions, which when executed by the at least one processor configure the at least one server to:
receive an initial image of the animal captured at a remote device;
process the initial image to identify facial component locations including at least two eyes; and
normalize the received initial image based on the identified facial component locations to provide the image.

22. The system of claim 21, wherein normalizing the received initial image comprises:
normalizing the alignment, orientation and or size of the initial image to provide a normalized front-face view.

23. The system of claim 15, wherein the one or more remote computing devices each comprise:
a remote processing unit for executing instructions; and
a remote memory unit for storing instructions, which when executed by the remote processor configure the remote computing device to:
receive an initial image of the animal captured at the remote computing device;
process the initial image to identify facial component locations including at least two eyes; and
transmit a plurality of the identified facial component locations, including the two eyes, to the server with the initial image.

24. The system of claim 15, wherein retrieving the plurality of animal profiles comprises:
retrieving the plurality of animal profiles from a data store storing profiles of animals that have been reported as located.

25. The system of claim 26, wherein the at least one memory further stores instructions, which when executed by the at least one processor configure the at least one server to:
determine that all of the respective match values between image features identified in the image and image features of each of the retrieved animal profiles are below a matching threshold;
retrieve a second plurality of animal profiles associated with the determined classification label of the animal, the second plurality of animal profiles retrieved from a second data store storing animal profiles; and
determine a respective match value between image features identified in the image data and image features of each of the retrieved second plurality of animal profiles.

26. The system of claim 27, wherein the second data store stores animal profiles that have been registered with the server.
